(19) United States
(12) Patent Application Publication
(10) Pub. No.: US 2003/0125011 A1
(43) Pub. Date: Jul. 3, 2003

(54) Method, network, and computer-readable medium for providing pre-paid telecommunication service incentives

(76) Inventor: Michael A. Campbell, Plano, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/035,722

(22) Filed: Dec. 28, 2001

(51) Int. Cl. H04M 11/00

(52) U.S. Cl. 455/406; 455/405

(57) ABSTRACT

A method of crediting a balance of a pre-paid subscriber account in a telecommunication network comprising receiving a voucher transaction by a node of the network, the voucher transaction including a voucher balance and a voucher discount value, obtaining an account balance and an account discount value of an account associated with the voucher transaction, and calculating a composite balance and a weighted discount, the weighted discount a function of the voucher balance, the voucher discount value, the account balance, and the account discount value is provided. A telecommunication network comprising a node operable to perform switching services between at least two telecommunication devices, the network operable to receive a voucher transaction including a voucher identifier and a subscriber identifier, the node operable to obtain a voucher balance, a voucher discount value, an account balance and an account discount value, the node further operable to calculate a composite balance and a weighted discount calculated as a function of the voucher balance, the voucher discount value, the account balance, and the account discount value is provided.

### TECHNICAL FIELD OF THE INVENTION

This invention relates to pre-paid telecommunication services and, more particularly, to a method, network, and computer-readable medium for providing pre-paid telephone services on an incentive basis.

### BACKGROUND OF THE INVENTION

A prepaid calling card, also known as a phone debit card, allows users to pre-pay a selected amount of charges for telephone services, such as charges assessed for completing telephone calls. A subscriber account record may maintain a balance indicative of a monetary credit against which tariffs may be levied for services provided to a subscriber. When the subscriber makes a telephone call or otherwise incurs charges for telephone services, the charges for the provided services are deducted from the account balance. Pre-paid accounts may periodically be ‘recharged’ by purchase of a pre-paid phone services card (also referred to herein as a ‘pre-paid card’) that has a monetary value associated therewith. Pre-paid telephone service cards have become increasingly popular in recent years, particularly among travelers who wish to avoid the additional expenses incurred when using calling cards which bill charges to a designated telephone number or credit card. In addition, a pre-paid card allows the user to both carefully monitor usage and avoid the use of unknown long distance carriers, thereby preventing the user from receiving unexpectedly large telephone bills on his or her return home.

Generally, when purchased or otherwise acquired, a pre-paid card includes a voucher identification that may be indexed against a database of voucher records. A voucher balance, such as a retail value of the pre-paid card, may be stored within a record of the voucher database containing the voucher identification. A subscriber account identification, or alternatively a terminal device identifier such as a cellular telephone international mobile station equipment identity (IMEI), may be provided to a processing node, such as a service control point of a telecommunication network, along with the voucher identification. The service control point may then interrogate the voucher database and obtain the voucher balance associated with the pre-paid card identified by the voucher identification. A processing module may then deduct units from an account balance of a subscriber account record based on an airtime rate, such as a specified monetary unit per duration, when a call is placed.

Voucher purchases that may be applied to a subscriber account balance are commonly sold by pre-paid telephone service providers on an incentive basis. Prior art incentive-based pre-paid telecommunication services include mapping techniques that associate a voucher balance, or monetary value, with an airtime rate. When an account is recharged in a system implementing such a method, an airtime rate associated with the voucher is set and tariffs levied against a call, that is deductions made against a subscriber account balance, are made according to the air-time rate associated with the most recently purchased voucher. While such a technique is easy to implement and simple for a subscriber to understand, the air-time rate is inflexibly, and often disadvantageously, associated with the voucher balance. For example, a subscriber may make a first pre-paid transaction having a voucher airtime rate associated therewith. A later pre-paid voucher transaction having a different airtime rate will then override the previous airtime rate. In the event the subscriber account balance has not been consumed at the time of the later pre-paid transaction, the subscriber may have tariffs levied against the prepaid account at a greater or lower airtime rate than previously made dependent on the relative size of the most recently purchased voucher. Such a technique may therefore provide a disincentive for additional credit purchases made with smaller denominations when a subscriber account record includes a residual balance at the time of the additional voucher purchase.

To alleviate the abovedescribed problems related to associating a voucher balance with an airtime rate, pre-paid operators have implemented a per-voucher balance incentive that associates an airtime rate with each voucher purchased. Per-voucher balance incentive techniques advantageously levy airtime rates directly against an account balance associated with the purchase of a voucher specifying the airtime rate. However, such a technique complicates maintenance of subscriber accounts. For example, multiple voucher purchases having respectively different voucher balances and airtime rates require additional complexity, such as multiple account balances, within a subscriber account record. Thus, it may be seen from the foregoing that an incentive technique that allows decoupling of a voucher balance and a pre-paid airtime rate is advantageous.

### SUMMARY OF THE INVENTION

In accordance with an embodiment of the present invention, a method of crediting a balance of a pre-paid subscriber account in a telecommunication network comprising receiving a voucher transaction by a node of the network, the voucher transaction including a voucher balance and a voucher discount value, obtaining an account balance and an account discount value of an account associated with the voucher transaction, and calculating a composite balance and a weighted discount, the weighted discount a function of the voucher balance, the voucher discount value, the account balance, and the account discount value is provided.

In accordance with another embodiment of the present invention, a telecommunication network operable to provide pre-paid telecommunication services comprising a node operable to perform switching services between at least two telecommunication devices, a first database including a subscriber record having an account balance field and an account discount field, a second database including a voucher record having a voucher balance field and a voucher discount value field, the network operable to receive a voucher transaction including a voucher identifier and a subscriber identifier, the node operable to interrogate the second database with the voucher identifier and obtain a voucher balance and a voucher discount value, the network operable to interrogate the first database and obtain an account balance and an account discount value from the subscriber record, the node operable to calculate a composite balance and a weighted discount, the weighted discount calculated as a function of the voucher balance, the voucher discount value, the account balance, and the account discount value is provided.

In accordance with another embodiment of the present invention, a computer-readable medium having stored thereon a set of instructions to be executed, the set of instructions, when executed by a processor, cause the processor to perform a computer method of reading a voucher identifier, reading a subscriber identifier, interrogating a first database with the voucher identifier, retrieving a voucher balance and a voucher discount value from the first database, interrogating a second database with the subscriber identifier, retrieving an account balance and an account discount value from the second database, and calculating a composite balance and a weighted discount that is a function of the account balance, the account discount value, the voucher balance, and the voucher discount value is provided.

In accordance with another embodiment of the present invention, a computer-readable medium having stored thereon a set of instructions to be executed, the set of instructions, when executed by a processor, cause the processor to perform a computer method of reading a subscriber identifier, retrieving an account balance and an account discount value of an account associated with the subscriber identifier, calculating an allowable duration as a function of the account balance and the account discount value, initiating a timer upon a call setup attributed to a subscriber having the account assigned thereto, and deducting units from the account balance, the units deducted based upon a timed duration accumulated by the timer, an airtime rate, and the account discount value is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a telecommunication network that includes an interexchange carrier that may have one or more local exchange carriers coupled thereto and in which the present invention may be employed;

FIG. 2 is a more detailed block diagram of a switch and a service control point of the telecommunication network of FIG. 1;

FIG. 3 is a block diagram of a mobile telecommunications system in which the present invention may be employed;

FIG. 4 is a block diagram of a portion of a mobile telecommunication system in a configuration for recharging a pre-paid account according to the prior art;

FIG. 5 is a processing schematic of a service control point according to an embodiment of the present invention;

FIG. 6 illustrates a weighted discount function processing flow that may be executed by a service control point according to an embodiment of the present invention;

FIG. 7 is a flowchart of an exemplary account handling module processing sequence for recharging a subscriber account according to an embodiment of the present invention;

FIG. 8 is a flowchart of an exemplary account handling module processing sequence for charging a subscriber account for telecommunication services provided to a subscriber assigned to the subscriber account according to an embodiment of the present invention; and

FIG. 9 is a block diagram of a node that may maintain and execute an account handling module according to an embodiment of the present invention.

### DETAILED DESCRIPTION OF THE DRAWINGS

The preferred embodiment of the present invention and its advantages are best understood by referring to FIGS. 1 through 9 of the drawings, like numerals being used for like and corresponding parts of the various drawings.

In FIG. 1, there is illustrated a telecommunication network 100, such as a public switched telephone network, that includes an interexchange carrier 10 that may have one or more local exchange carriers (LECs) 20-21, such as regional Bell operating companies, coupled thereto and in which the present invention may be employed for advantage. Interexchange carrier 10 generally includes various switching systems 40-41, such as DMS-250 switches manufactured by Nortel Networks, Inc., for establishing circuit switched and/or packet switched connections between telephone terminals 30-31. LECs 20-21 likewise may include various switching systems and may provide connections between a telephone terminal coupled thereto and another telephone terminal within telecommunication network 100. Other telephone terminals may be coupled to interexchange carrier 10, for example via a private branch exchange 50 as well. A service control point (SCP) 70 may include, or be interconnected with, one or more databases and may be connected to a switch 40 and, in coordination therewith, may monitor and control the use of pre-paid telecommunication service accounts (also referred to herein as ‘pre-paid accounts’). Telecommunication network 100, as illustrated, is greatly simplified to facilitate a discussion of the subject invention and will generally include various components and subsystems omitted from the figure.

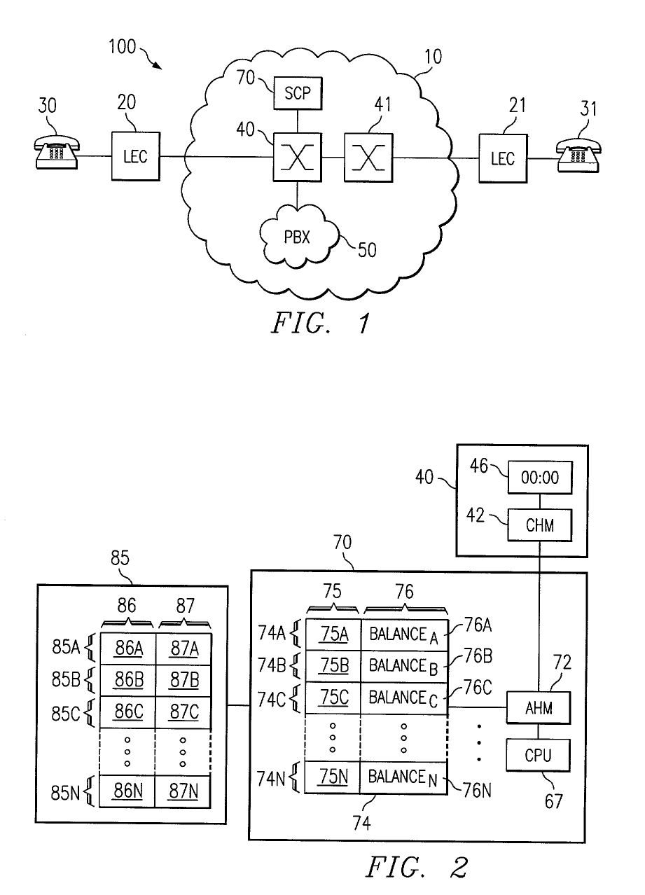

In FIG. 2, there is shown a more detailed block diagram of switch 40 and SCP 70. Switch 40 includes a call handling module (CHM) 42 that moderates exchanges between LEC 20, switch 41, and SCP 70 when a call is initiated by a telephone terminal, such as telephone terminal 30, by access to a pre-paid account. Switch 40 may include a digital timing module 46 for monitoring the duration of calls serviced thereby.

SCP 70 includes an account handler module (AHM) 72, a subscriber database 74, and a central processing unit (CPU) 67. Account handler module 72 is preferably implemented as a software module retrievable and executable by CPU 67. AHM 72 preferably manages requests for account information received from switch 40, retrieves requested information stored in a subscriber database 74, and transmits requested information to switch 40. Subscriber database 74 includes subscriber records 74A-74N that may be respectively indexed by a key value, such as an account identifier 75A-75N, maintained in a key field 75. AHM 72 may also update account information in subscriber database 74 as well. Subscriber database 74 may include an account balance field 76 having elements maintaining an account balance 76A-76N of an associated subscriber record 74A-74N.

In one existing technique, a pre-paid subscriber purchases, from a service provider or retailer, a pre-paid card having a voucher identifier that may be used to index a voucher record 85A-85N of a voucher database 85. The subscriber may provide account identifier 75A-75N to SCP 70 along with a voucher identifier 86A-86N. Voucher database 85 may include a key field 86 that allows a voucher record 85A-85N to be indexed, for example by interrogation of database 85 with a voucher identifier 86A-86N, and a voucher balance 87A-87N to be retrieved from an associated element of a voucher balance field 87. Account balances 76A-76N and voucher balances 87A-87N are preferably maintained as numerical values indicative of a monetary value of respective account balances and voucher balances. Account balance 76A-76N may be incremented by a denomination, or voucher balance, that is retrieved from voucher record 85A-85N indexed by voucher identifier 86A-86N supplied by the pre-paid subscriber. Later, the user dials into a switch operated by the service provider from which the user has purchased the pre-paid card and provides the switch, for example via dual-tone multi-frequency input, with account identifier 75A-75N. The service provider searches subscriber database 74 for the subscriber account. If an indexed subscriber record 74A-74N has a sufficient account balance 76A-76N, a tariff may be levied against the indexed subscriber record 74A-74N by deducting units representative of a monetary amount from account balance 76A-76N. Switch 40 may then copy account balance 76A-76N thereto and authorize the subscriber to begin a phone call which may continue until the user releases the call or until the copied account balance 76A-76N has been consumed. During a call in progress, SCP 70 may reduce the account balance 76A-76N by a pre-defined or calculated rate, also referred to herein as an airtime rate, and when the call is released, SCP 70 will update account balance 76A-76N in subscriber database 74 with an account balance having an amount deducted therefrom during the call progress. Furthermore, SCP 70 may direct switch 40 to disconnect the call upon balance 76A-76N reaching a minimum balance threshold specified by the network operator.

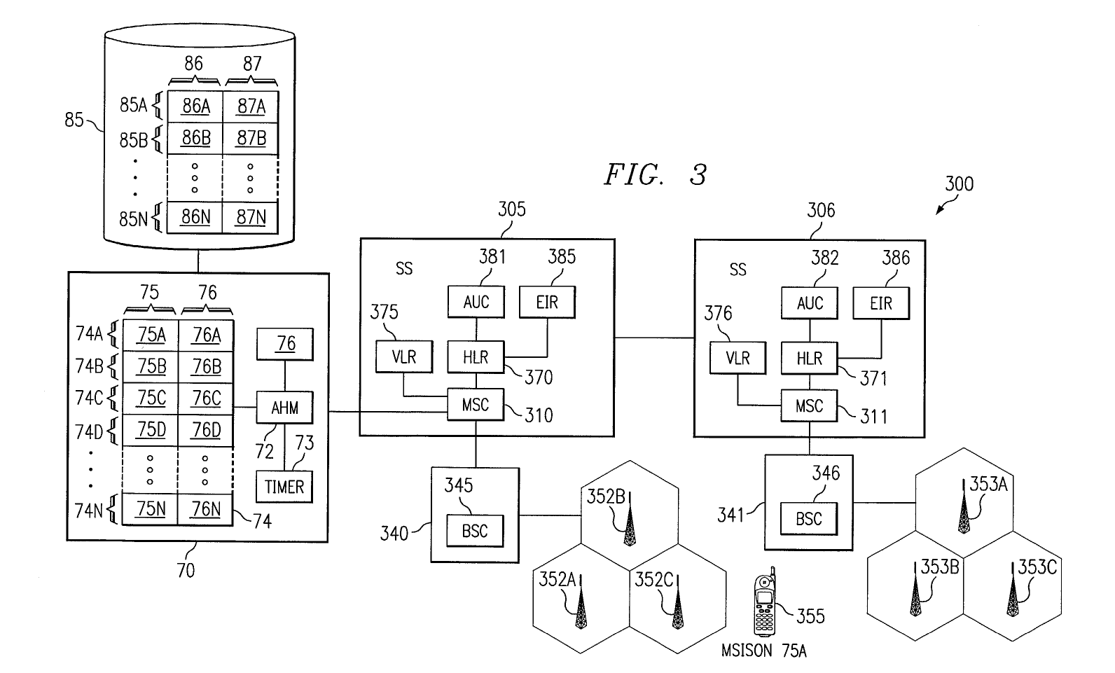

With reference now to FIG. 3, there is shown a block diagram of a mobile telecommunications system (MTS) 300, such as a global system for mobile communications, in which the present invention may be employed. Cellular telecommunication services are provided to one or more mobile terminals (MTs) 355. MTS 300 generally includes one or more switching systems (SSs) 305-306 and base station subsystems (BSSs) 340-341. The mobile terminal 355 can take on various forms other than a traditional cellular telephone, for example mobile terminal 355 may be a laptop computer with a wireless modem capable of mobile terminations, a wireless personal digital assistant, etc. Mobile terminal 355 communicates directly with one or more base transceiver stations (BTSs) 352A-352C and 353A-353C that operate under coordination of a base station controller (BSC) 345-346 and that collectively therewith comprise a respective base station subsystem BSS 340-341. Each BSS, for example BSS 340, will typically include one or more geographically diverse BTSs, for example BTSs 352A-352C. A group of BTSs, for example one of a BTS group 352-353, is managed by a base station controller (BSC) 345-346, also referred to as a radio network controller, that, in turn, communicates with, and is controlled by, a respective mobile services switching center (MSC) 310-311 included within a switching system (SS) 305-306. Each individual BTS 352A-352C and 353A-353C defines a radio cell operating on a set of radio channels thereby providing service to one or more mobile terminals (MTs) 355. Accordingly, each BSC 345-346 will have a number of cells corresponding to the respective number of BTSs 352A-352C and 353A-353C controlled thereby.

The switching system 305-306 contains a number of functional units implemented in various hardware and software. Generally, each SS 305-306 respectively contains an MSC 310-311, a Visitor Location Register (VLR) 375-376, a Home Location Register (HLR) 370-371, an Authentication Center 381-382, and an Equipment Identity Register 385-386. Mobile terminal 355 operable within MTS 100 has a register designated as a home register. In the present illustration, and in the examples provided hereinbelow, HLR 371 represents the home register of mobile terminal 355. HLR 371 is a database containing profiles of mobile terminals having HLR 371 designated as the home register. The information contained within the subscriber profile in HLR 371 includes various subscriber information, for example authentication parameters such as an international mobile station equipment identity (IMEI) that may be compared with the IMEI stored in a subscriber identity module (SIM) of MT 355 for authentication purposes, an electronic serial number (ESN) and an authentication capability parameter as well as subscription service parameters such as an access point name (APN) that defines the services included in the subscription. Additionally, a subscriber profile of MT 355 in HLR 371 contains data related to the current, or last known, location of MT 355 within MTS 300, for example a location area identifier. The location data contained within HLR 371 associated with MT 355 is dynamic in nature, that is it changes as MT 355 moves throughout MTS 300. It should be understood that each MSC 310-311 may, and typically does, control more than one BSC 345-346.

VLR 375-376 is a database that contains information about all MTs 355 currently being serviced by MSC 310-311 associated therewith. For example, VLR 376 will include information relating to each MT being serviced by MSC 311 and thus includes information associated with all MTs currently serviced by BTSs 353A-353C that are controlled by the associated BSC 346. When MT 355 enters a cell coverage area of a BTS controlled by another MSC, for example when MT 355 roams into the coverage area provided by BTS 352C, VLR 375 of SS 305 associated with BTS 352C will interrogate HLR 371 for subscriber information relating to MT 355. This information is then transferred to VLR 375. At the same time, VLR 375 transmits location information to HLR 371 indicating the new position of MT 355. The HLR profile associated with MT 355 is then updated to properly indicate the position of MT 355. This location information is generally limited to a location area identifier. The information transmitted to VLR 375 associated with a roaming MT 355 generally allows for call setups and processing for MT 355 without further interrogation of HLR 371 authentication and subscription service parameters of MT 355. Thus, when MT 355 attempts to perform or receive a call, SS 305 has the requisite information for performing the setup and switching functions to properly service MT 355. Additionally, VLR 375 will typically include more precise location information on MT 355 than HLR 371. For example, VLR 375 may contain a BSC identifier indicating the particular BSC servicing MT 355. VLRs 375-376 may assign a temporary mobile subscriber identifier (TMSI) to MT 355 that is relevant only in the area serviced by the SS maintaining that particular VLR. When MT 355 leaves a visited service area of an MSC, the VLR information on MT 355 therein may be destroyed.

Each SS 305-306 may also include an authentication center (AUC) 381-382 connected to HLR 370-371 of the respective SS 305-306. AUC 381-382 provides authentication parameters to HLR 370-371 for authenticating MT 355-356. AUC 381-382 may also generate ciphering keys used for securing communications with MT 355. Additionally, each SS 305-306 may also include an equipment identity register (EIR) 385-386 database that contains the international mobile station equipment identity used to uniquely identify MT 355. EIR 385-386 is used to validate MT 355 requesting service in MTS 300.

An operator of MTS 300 may provide pre-paid cellular telecommunication services in a manner similar to that described above with reference to telecommunication network 100. For example, a subscriber database 74 may be included within, or interconnected with, SCP 70 that is connected with SS 305 and may maintain subscriber records 74A-74N that respectively include a subscriber account balance 76A-76N in an account balance field 76 thereof. An account identifier 75A-75N, such as an MSISDN, may be provided to MSC 310 at call setup and MSC 310 may pass control of the call to SCP 70. Thereafter, SCP 70 may interrogate subscriber database 74 with account identifier 75A-75N and obtain contents, such as an account balance 76A-76N, of subscriber record 74A-74N indexed by account identifier 75A-75N. AHM 72 may then calculate, or otherwise obtain, an airtime rate such as a monetary unit per call duration, that is used to calculate an allowed call duration. The airtime rate is also used to calculate monetary deductions made from an account balance while a call is in progress. If the account balance is sufficient, SCP 70 may direct MSC 310 to allow the call. Once the call has been connected, MSC 310 may notify SCP 70. Thereafter, SCP 70 may deduct unit/s, such as monetary units, from account balance 76A-76N according to the airtime rate. Deductions to account balance 76A-76N may be facilitated by a timer 46 maintained by SCP 70 that measures a call duration in progress. A product of the call duration and the airtime rate may be deducted from balance 76A-76N by SCP 70 to determine a remaining account balance while a call is in progress. If the calculated balance is exceeded by a specified threshold during the call, SCP 70 may notify MSC 310 to terminate the call. At the end of a successful call, SCP 70 may notify MSC 310 of billing information related to the call and MSC 310 may later transmit the billing information to an accounting node, such as a charging gateway function.

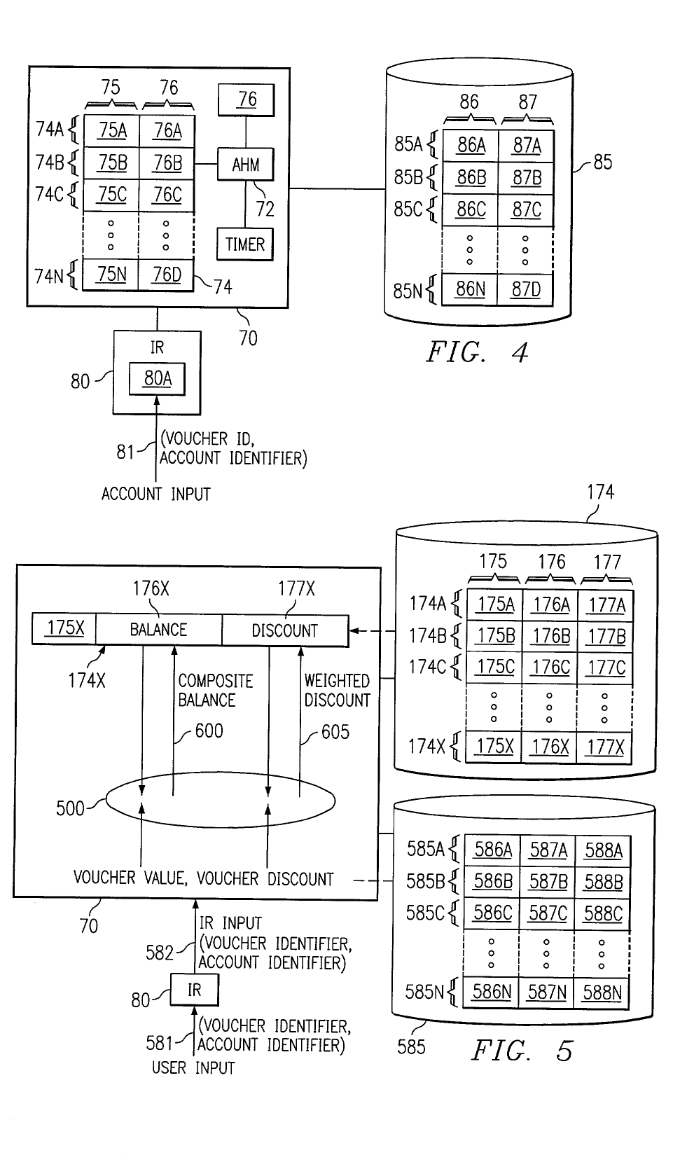

Customers may periodically ‘recharge’ a prepaid account by adding a monetary value to an account balance as illustrated by the block diagram of FIG. 4 illustrating a portion of MTS 300 in a configuration for recharging a pre-paid account according to the prior art. A prepaid account subscriber may purchase a credit voucher from an outlet, such as a convenience store. A credit voucher generally includes a voucher balance (or ‘denomination’), such as a dollar amount, and a voucher identifier. Upon purchase of the voucher, the customer may then contact an interactive response node (IR) 80 that provides an interface to SCP 70. IR 80 may include an interactive function 80A, such as a voice recognition function, dual-tone multi-frequency function, or another module that facilitates interpretation of a transaction input 81 made by a subscriber. IR 80 may be interconnected with a public network, such as the Internet, that facilitates input by a user from a remote terminal connected with the network as well. Transaction input 81 may include an account identifier and a voucher identifier. As mentioned hereinabove, transmission of the account identifier to IR 80 may be made in an automated manner, such as by transmission of an IMEI associated with a terminal device during call setup with IR 80. IR 80 may then forward the voucher identifier to SCP 70. Thereafter, SCP 70 may interrogate a voucher database 85 interconnected therewith. Voucher database 85 preferably includes a table of records 85A-85N that may be respectively indexed by a voucher identifier 86A-86N maintained in a key field 86 thereof. Interrogation of voucher database 85 with a valid voucher identifier 86A-86N results in retrieval of a voucher balance 87A-87N stored in a voucher balance field 87 of the indexed record 85A-85N by AHM 72. Thereafter, AHM 72 may credit, or increment, account balance 76A-76N of the indexed subscriber record 74A-74N by voucher balance 87A-87N.

As mentioned hereinabove, it is desirable to provide incentives for large denomination purchases of prepaid services to a pre-paid account subscriber. The present invention provides a balance weighted discount multiplier (also referred to herein as a ‘weighted discount’) that may be utilized by SCP 70 to decouple an airtime rate and a voucher balance accumulated over multiple voucher purchases, as illustrated by the processing schematic of SCP 70 in FIG. 5 according to an embodiment of the present invention. An account discount value 177X is included within a subscriber record 174X that may be used by SCP 70 in calculating an allowed call duration from a balance 176X of subscriber record 174X. For example, during a call setup, AHM 72 may calculate a maximum duration, for example a maximum call duration in minutes, available for a particular account balance 176X. A discount value 177X may be implemented, for example activation of an airtime discount due to a previous pre-paid voucher value and/or an account balance 176X equaling or exceeding an incentive offered by MTS 300 operator. A calculation of an allowable call duration may be made that is a function of balance 176X and discount value 177X, an exemplary discount duration taking the form:

$$Duration = \frac{Account\_Balance}{Account\_Discount \_Value \times airtime\_rate}$$

For example, an account balance having units of dollars and an airtime rate having units of dollars per unit minutes results in a duration calculation of minutes. Thus, a value of account discount value 177X less than unity results in a duration calculation that is greater than a non-discounted call having an identical account balance 176X and airtime rate. Accordingly, by including account discount value 177X within a duration calculation made by AHM 72, a pre-paid subscriber may be provided an incentive, such as additional available airtime per unit account balance 176X, to maintain a balance 176X value specified by network 300 operator and/or to make pre-paid transactions of a specified value.

The present invention provides additional advantage by facilitating decoupling of account discount value 177X with a pre-paid voucher balance. In the present illustrative example, a subscriber having account information maintained in subscriber record 174X has account balance 176X and account discount value 177X prior to purchasing a pre-paid voucher and providing voucher transaction input 581 to IR 80. Voucher transaction input 581 may include a voucher identifier and an account identifier 175X and may be forwarded to SCP 70. SCP 70 interrogates a key field 586 of a voucher database 585 and retrieves a voucher balance 587A-587N and a voucher discount 588A-588N from a voucher record 585A-585N indexed by voucher identifier 586A-586N. In the present example, assume voucher input 581 includes voucher identifier 586B. Accordingly, SCP 70 retrieves voucher balance 587B and voucher discount 588B from voucher database 585. A residual account balance 176X, that is an account balance prior to completion of the voucher transaction, as well as a residual discount value 177X may be retrieved from subscriber record 174X by interrogating subscriber database 174 with account identifier 175X. Residual account balance 176X and residual account discount value 177X may be input into a weighted discount function 500. SCP 80 also inputs voucher balance 587B and voucher discount value 588B into weighted discount function 500. Discount function 500 then performs a weighted discount computation based on the input thereto and writes a new composite balance 600 and a new weighted discount 605 into respective account balance 176X and account discount value 177X elements of subscriber record 174X. An allowable call duration may then be calculated by SCP 70 as a product of account balance 176X, account discount value 177X, and an airtime rate. Thus, tariffs levied against an account balance may be reduced from a non-discounted airtime rate by performing a duration calculation with a weighted discount. While voucher discount value 588A-588N is shown and described stored in a discount field 588 of voucher database 585, other configurations are possible and may be advantageous. For example, voucher database 585 may only include a key field 586 (or voucher identifier field) indexable by voucher identifier 586A-586N and voucher balance field 587 including elements maintaining voucher balances 587A-587N indexable by respective voucher identifiers 586A-586N while voucher discount values 587A-587N may be stored in another location, such as within a database maintained by SCP 70. As another alternative, voucher database 585 may only store voucher identifiers 586A-586N for voucher authentication purposes. A separate database may be maintained by another entity, such as SCP 70, and may store voucher balances 586A-586N as key values used to retrieve voucher discount values stored therewith. A configuration such as the latter alternative facilitates implementation of the invention with only modifications to SCP 70 rather than modifying both SCP 70 and a conventional voucher database. Those skilled in the art will recognize other configurations are possible without departing from the invention.

Preferably, weighted discount function 500 performs a balance sum of a residual account balance 176X and a voucher balance and averages the airtime rates thereof. Accordingly, composite balance 600 may be calculated as a sum of voucher balance 587A-587N and residual balance 176X and an account discount value 177X may be calculated as a weighted computation that is a function of a residual account balance, a residual account discount value, a voucher balance, and a voucher discount value.

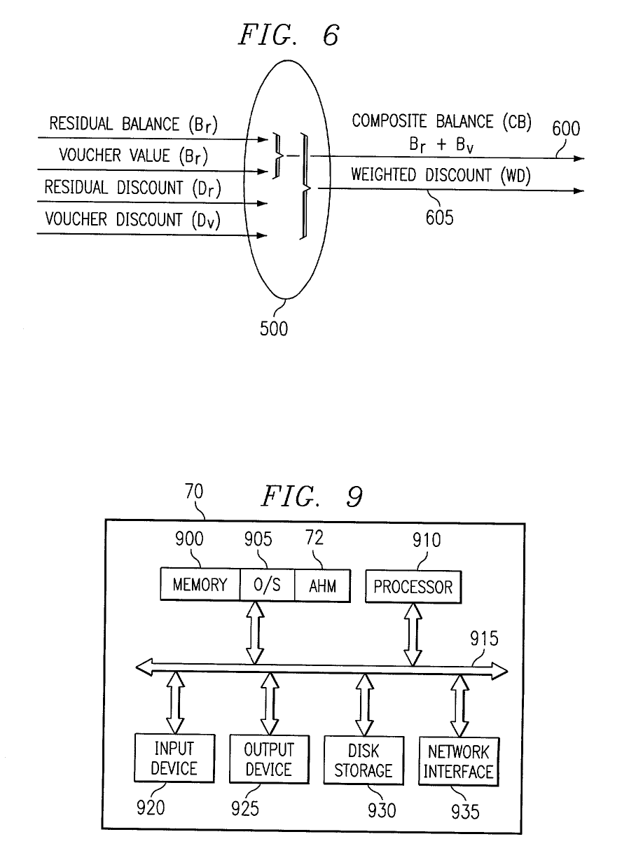

With reference now to FIG. 6, there is shown a preferred weighted discount function 500 processing flow that may be executed by SCP 70 according to an embodiment of the present invention. Weighted discount function 500 receives a residual account balance (Bᵣ) 176x that represents a monetary account balance prior to computation of a voucher transaction. A voucher balance (Bᵥ) 587A-587N is received by weighted discount function 500 and summed with residual account balance 176X to yield an adjusted balance, or composite balance (CB) 600, of a subscriber account after processing of a voucher transaction. Additionally, a residual account discount value (Dᵣ) 177X is input into weighted discount function 500 that represents a discount that may be applied to deductions of an account balance while levying, or calculating, fees associated with telecommunication services provided to a pre-paid subscriber. A voucher discount (Dᵥ) 588A-588N is also input into weighted discount function 500. A new weighted discount may then be calculated according to the formula:

$$Weighed Discount = \frac{{B}_{r}}{CB} \times {D}_{r} + \frac{{B}_{v}}{CB} \times {D}_{v}$$

An allowed call duration may then be calculated as a product of the weighted discount, an airtime rate, and a composite balance according to the equation:

$$Duration = \frac{Composite\_Balance}{Weighted\_Discount \times airtime\_rate}$$

Likewise, a call in progress may have units deducted from the account balance as a function of the weighted discount and the airtime rate according to the equation:

Balance=Balance−(Weighted_Discount×airtime_rate)

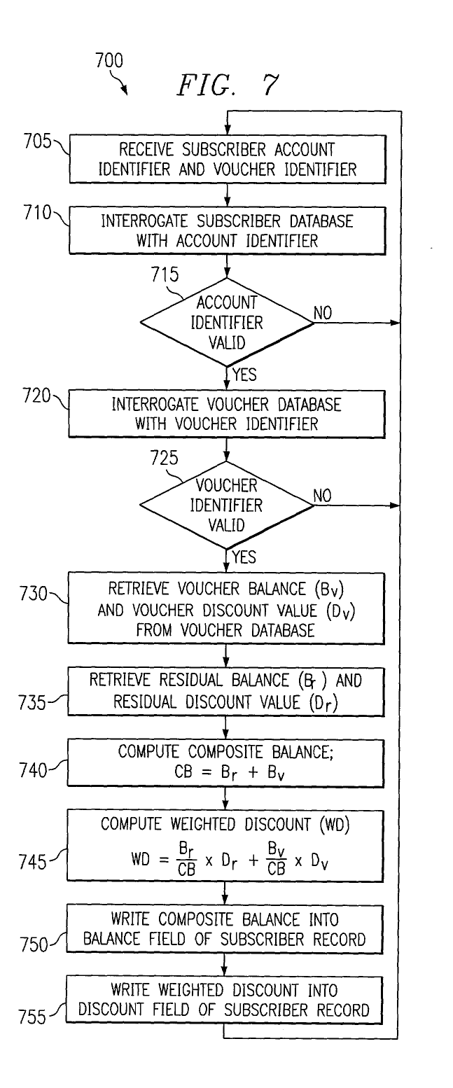

In FIG. 7, there is shown a flowchart of an exemplary AHM 72 processing sequence for recharging a subscriber account according to an embodiment of the present invention. AHM 72 receives subscriber account identifier 175A-175X and a voucher identifier 586A-586N (step 705). AHM 72 interrogates subscriber database 174 with account identifier 175A-175X (step 710) and determines whether account identifier 175A-175X is valid (step 715). An invalidation of account identifier 175A-175X may be made, for example, by reception of an error message from subscriber database 174. Invalidation of account identifier 175A-175X results in AHM 72 processing returning to await reception of another voucher identifier and account identifier. Upon authentication of account identifier 175A-175X, AHM 72 interrogates voucher database 585 with voucher identifier (720) and determines whether voucher identifier 586A-586N is valid (step 725). An invalidation of a voucher identifier may be made, for example, by return of an error message from voucher database 585 upon input of voucher identifier 586A-586N thereto. Invalidation of voucher identifier 586A-586N results in AHM 72 processing returning to await reception of another voucher identifier and subscriber identifier. Upon validation of a voucher identifier 586A-586N, voucher balance 587A-587N and voucher discount value 588A-588N may be retrieved from the respective voucher record 585A-585N indexed by voucher identifier 586A-586N (step 730). Account balance 176A-176X and account discount value 177A-177X are retrieved from subscriber record 174A-174X indexed by subscriber identifier 175A-175X (step 735) as well.

A composite balance 600 is then computed by summing account balance 176A-176X with voucher balance 587A-587N (step 740). A weighted discount 605 is then computed, for example by summing the product of the residual account balance and residual account discount value with the product of the voucher balance and the voucher discount and determining the quotient of the sum with the composite balance (step 745). The composite balance and the weighted discount may then be written into the respective balance field and discount field of the subscriber record indexed by subscriber identifier 175A-175X.

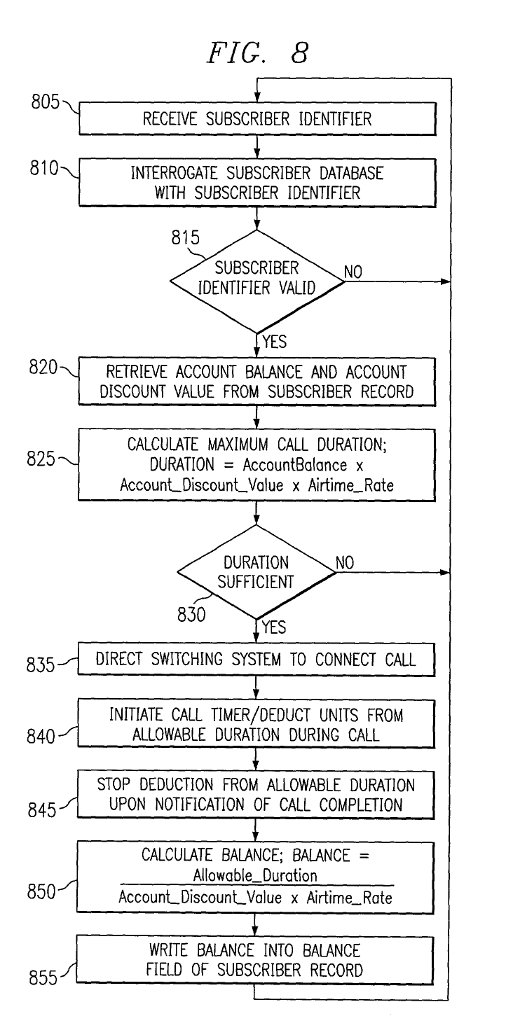

With reference now to FIG. 8, there is shown a flowchart 800 of an exemplary AHM 72 processing sequence for charging a subscriber account for telecommunication services provided to a subscriber assigned to the subscriber account according to an embodiment of the present invention. A subscriber identifier 175A-175X is received, for example during call setup, by AHM 72 (step 805). Subscriber database 174 is interrogated by AHM 72 with subscriber identifier 175A-175X (step 810) and AHM 72 determines whether subscriber identifier 175A-175X is valid. An invalidation of subscriber identifier 175A-175X may be made, for example by reception of an error message from subscriber database 174. Invalidation of subscriber identifier 175A-175X results in AHM 72 processing returning to await reception of another subscriber identifier 175A-175X. Upon validation of subscriber identifier 175A-175X, account balance 176A-176X and account discount value 177A-177X are retrieved from subscriber record 174A-174X indexed by subscriber identifier 175A-175X (step 820). A maximum call duration is then calculated by AHM 72, for example by calculating the product of account balance 176A-176X, account discount value 177A-177X, and an airtime rate (step 825). The call may then be allowed or disallowed, for example by determining whether the calculated duration is sufficient for allowing the call (step 830). Disallowance of the call results in AHM 72 processing returning to await reception of another subscriber identifier 175A-175X.

Upon determining that the calculated duration is sufficient for allowing the call, AHM 72 may direct a switching system to connect the call (step 835). Thereafter, a timer 46 may be initiated and units, such as monetary units, may be deducted from the account balance as a function of the airtime rate and the weighted discount (step 840). Upon notification of call termination, deductions from the balance are halted (step 845). The remaining balance may then be written into balance field 176 of subscriber record 174A-174X indexed by subscriber identifier 175A-175X during call setup (step 850) and AHM 72 processing may return to await reception of another subscriber identifier.

As embodiments of AHM 72, components thereof, and associated functionality may be implemented in hardware, software, firmware, or a combination thereof, those embodiments implemented at least partially in software can be adapted to run on different platforms and operating systems. In particular, logical functions implemented by AHM 72 may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

In the context of this document, a “computer-readable medium” can be any means that can contain, store, communicate, propagate or transport the executable instructions for use by, or in connection with, the instruction execution system, apparatus, or device. The computer readable medium can be, for example, but is not limited to, an electronic, magnetic, optical, electromagnetic, infrared, or semi-conductor system, apparatus, device, or propagation medium. More specific examples of the computer-readable medium include an electrical connection having one or more wires, a portable computer diskette, a random access memory (RAM), a read-only memory (ROM), an erasable, programmable, read-only memory (EPROM or Flash memory), an optical fiber, and/or a portable compact disk read-only memory (CDROM).

With reference now to FIG. 9, there is a block diagram of a node, such as SCP 70, that may maintain and execute AHM 72 according to an embodiment of the present invention. SCP 70 may store AHM 72 as a computer-executable instruction set in a memory unit 900. AHM 72 may be stored in disk storage 930, loaded into memory device 900, and executed therefrom. Through conventional techniques, AHM 72 is executed by an operating system 905 and one or more processing elements 910 such as a central processing unit. Operating system 905 performs functionality similar to conventional operating systems, such as controlling the resources of SCP 70 through conventional techniques and interfacing the instructions of AHM 72 with processing element 910 as necessary to enable AHM 72 to run properly.

Processing element 910 communicates to and drives other elements within SCP 70 via a local interface 915 which may be implemented as one or more buses. Furthermore, an input device 920, for example a keyboard or a mouse, can be used to input data from a user of SCP 70, and an output device 925, for example a display device or a printer, can be used to output data to the user. A disk storage device 930 can be connected to local interface 915 to transfer data to and from a nonvolatile disk, for example a magnetic disk, optical disk, or another device. SCP 70 is preferably connected to a network interface 935, such as a T1, E1, Ethernet or other network interface, that facilitates exchanges of data with a network, such as telecommunication network 100 and/or mobile telecommunications system 300. Databases, such as subscriber database 174 and voucher database 585 may be stored in storage device 930, memory unit 900, and/or an external entity accessed by SCP 70 via network interface 935.

As described, a pre-paid incentive technique that allows decoupling of a voucher balance and a pre-paid airtime is provided. Pre-paid vouchers may be sold and a pre-paid account balance may be adjusted by the value of the pre-paid voucher. A weighted discount function may be calculated that is a function of a residual account balance, a voucher balance, a residual account discount value, and a voucher discount value. Thus, a provider of pre-paid telecommunication services may provide incentives in the form of additional air-time per unit balance while providing an account balance obtained from a direct sum of a residual account balance and a pre-paid voucher balance.

While the invention has been particularly shown and described by the foregoing detailed description, it will be understood by those skilled in the art that various changes, alterations, modifications, mutations and derivations in form and detail may be made without departing from the spirit and scope of the invention.

What is claimed is:

1. A method of crediting a balance of a pre-paid subscriber account in a telecommunication network, comprising:
receiving a voucher transaction by a node of the network, the voucher transaction including a voucher balance and a voucher discount value;
obtaining an account balance and an account discount value of an account associated with the voucher transaction; and
calculating a composite balance and a weighted discount, the weighted discount a function of the voucher balance, the voucher discount value, the account balance, and the account discount value.

2. The method according to claim 1, wherein receiving a voucher transaction further comprises receiving a voucher transaction including an account identifier that specifies the account associated with the voucher transaction.

3. The method according to claim 1, wherein obtaining an account balance further comprises interrogating a subscriber database with an account reference that specifies the account associated with the voucher transaction, the account reference indexing a subscriber record of the subscriber database, the subscriber record maintaining the account balance.

4. The method according to claim 3, wherein calculating a composite balance and a weighted discount further comprises:
calculating the composite balance by summing the account balance and the voucher balance; and
calculating the weighted discount by calculating a first product of the account balance and the account discount value, calculating a second product of the voucher balance and the voucher discount value, calculating a sum of the first product and the second product, and calculating the quotient of the sum and the composite balance.

5. The method according to claim 4, further comprising: writing the composite balance into a balance field of the subscriber record; and writing the weighted discount into a discount field of the subscriber record.

6. A telecommunication network operable to provide pre-paid telecommunication services, comprising:
a node operable to perform switching services between at least two telecommunication devices;
a first database including a subscriber record having an account balance field and an account discount field; and
a second database including a voucher record having a voucher balance field and a voucher discount field, the network operable to receive a voucher transaction including a voucher identifier and a subscriber identifier, the node operable to interrogate the second database with the voucher identifier and obtain a voucher balance and a voucher discount value, the network operable to interrogate the first database and obtain an account balance and an account discount value from the subscriber record, the node operable to calculate a composite balance and a weighted discount, the weighted discount calculated as a function of the voucher balance, the voucher discount value, the account balance, and the account discount value.

7. The network according to claim 6, wherein the composite balance is the sum of the voucher balance and the account balance.

8. The network according to claim 7, wherein the node is operable to write the composite balance into the balance field of the subscriber record and to write the weighted discount into the discount field of the subscriber record.

9. The network according to claim 6, wherein the node is a service control point and the network is a public switched telephone network, the network further comprising a central office interconnected with the service control point.

10. The network according to claim 6, wherein the node is a service control point and the network is a mobile telecommunication system, the network further comprising:
a base station subsystem including a base station controller and a base transceiver station operable to provide a radio-frequency link with a mobile device; and
a switching system including a mobile services switching center interconnected with the service control point, the subscriber identifier and the voucher identifier being transmitted from the mobile device to the base station subsystem over the radio-frequency link, the base station subsystem forwarding the subscriber identifier and the voucher identifier to the switching system, the switching system forwarding the subscriber identifier and the voucher identifier to the service control point.

11. A computer-readable medium having stored thereon a set of instructions to be executed, the set of instructions, when executed by a processor, cause the processor to perform a computer method of:
reading a voucher identifier;
reading a subscriber identifier;
interrogating a first database with the voucher identifier;
retrieving a voucher balance and a voucher discount value from the first database;
interrogating a second database with the subscriber identifier;
retrieving an account balance and an account discount value from the second database; and
calculating a composite balance and a weighted discount that is a function of the account balance, the account discount value, the voucher balance, and the voucher discount value.

12. The computer readable medium according to claim 11, wherein calculating a composite balance comprises summing the account balance and the voucher balance.

13. The computer readable medium according to claim 11, wherein calculating the weighted discount comprises calculating a first product of the account balance and the account discount value, calculating a second product of the voucher balance and the voucher discount value, calculating a sum of the first product and the second product, and calculating a quotient of the sum and the composite balance.

14. The computer readable medium according to claim 11, wherein interrogating a second database further comprises indexing a subscriber record with the subscriber identifier, the subscriber record including an account balance field and an account discount field therein, the account balance and the account discount value respectively included within the account balance field and the account discount field.

15. The computer readable medium according to claim 14, further comprising a set of instructions that, when executed by the processor, cause the processor to perform the computer method of:
writing the composite balance into the account balance field of the subscriber record; and
writing the weighted discount into the account discount field of the subscriber record.

16. A computer-readable medium having stored thereon a set of instructions to be executed, the set of instructions, when executed by a processor, cause the processor to perform a computer method of:
reading a subscriber identifier;
retrieving an account balance and an account discount value of an account record associated with the subscriber identifier;
initiating a timer upon a call setup attributed to a subscriber having the account assigned thereto; and
deducting units from the account balance, the units deducted based upon a timed call duration accumulated by the timer, an airtime rate, and the account discount value.

17. The computer-readable medium according to claim 16, wherein deducting units from the account balance further comprises deducting a product of the timed call duration, the airtime rate, and the discount value from the account balance.

18. The computer readable medium according to claim 16, further comprising a set of instructions that, when executed by the processor, cause the processor to perform the computer method of:
terminating deductions from the balance upon call termination; and
writing the balance having the units deducted therefrom into the record.
